(19) United States
(12) Patent Application Publication
(10) Pub. No.: US 2012/0327952 A1
(43) Pub. Date: Dec. 27, 2012

(54) ETHERNET TAG APPROACH TO SUPPORT NETWORKING TASK OFFLOAD

(75) Inventors: MANQING HUANG, Fremont, CA (US); ANDREW LACROIX, Ottawa (CA)

(73) Assignee: EXAR CORPORATION, Fremont, CA (US)

(21) Appl. No.: 13/167,586

(22) Filed: Jun. 23, 2011

(51) Int. Cl. H04L 12/56

(52) U.S. Cl. 370/419

(57) ABSTRACT

A two chip network adapter is used to implement offloaded networking tasks. The first chip is the main ethernet controller chip. The second chip implements the offloaded tasks. Communication between a host and the second chip is done by adding offload and completion tags to the ethernet frame header of frames associated with the offloaded networking task.

### FIELD OF THE INVENTION

The present application relates to the design of a network adapter that allows for offloading networking tasks.

### BACKGROUND

Networking tasks can require a large amount of processing. For this reason, some operating systems, such as the Windows® Operating System, allow for the offloading of certain networking tasks from the host to a network adapter, also called a network interface controller (NIC).

Offloaded networking tasks can include TCP/IP tasks, such as checksum offload, transmission control protocol (TCP) segmentation offload and Internet protocol security (IPSec) offload.

IPsec is a protocol for securing Internet protocol (IP) communications by authenticating and encrypting each IP packet in a communication session. IPsec also includes protocols to establish mutual authentication between agents and to negotiate the cryptographic algorithms and keys used for the communication.

To have a network adapter that allows for networking task offload typically requires that the chip is used in the network adaptor be designed such that it can implement the offloaded tasks. If additional offloaded networking tasks are to be supported by the network adapter, this chip needs to be redesigned.

### SUMMARY

Currently the classic networking task offload solution is a one-chip solution, in which the offload functionalities are integrated into the ethernet controller. This invention introduces an ethernet tag as a vehicle to carry the offload requests and offload completion statuses between the host and the device, thus the ethernet controller does not need to perform the offload tasks.

In the one-chip offload solution, a new task offload type is likely to require the change of the ethernet controller design. Using this invention, regular and well-defined networking tasks are implemented in the first chip of the controller; however, new task offload features are implemented in a second chip. The value of this invention is to enable modularized design of a network interface card to better support the changing requirements, in that the main (first) chip can be re-used while any new requirements can be supported by the second chip.

Embodiments of the present invention use a two-chip network adapter. The first chip implements the main ethernet controller. The second chip does the offloaded networking tasks. Communication between the host and the second chip, and optionally between the host and the first chip, is done using tags added to the Ethernet frame header of the Ethernet frames.

The added tags in the ethernet frame header allows for the shifting of the offloaded networking tasks to the second chip. New offloaded networking tasks can be added to the network adapter merely by redesigning the smaller and less complex second chip.

The use of the ethernet frame header allows for the data associated with the offloaded task to be indicated without requiring out-of-band communications.

### BRIEF DESCRIPTION OF THE DRAWINGS

FIG. 1 is a diagram that shows the flow of outgoing data through a two-chip network adapter.

FIG. 2 is a diagram showing the insertion of an offload tag into the ethernet frame header of ethernet frames.

FIG. 3 is a diagram that shows the flow of incoming data through a two-chip network adapter.

FIG. 4 is a diagram showing the insertion of a completion tag into the ethernet frame header of ethernet frames.

### DETAILED DESCRIPTION OF THE INVENTION

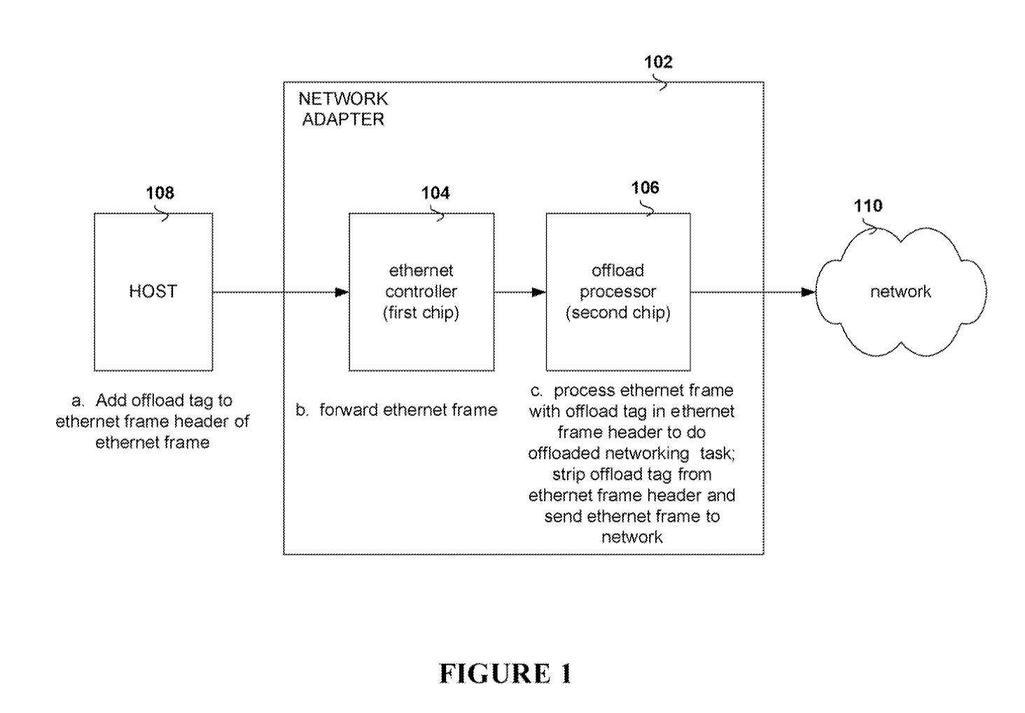

FIG. 1 shows an embodiment with a two-chip network adapter 102. The first chip 104 is a conventional ethernet controller chip that does not implement offloaded networking tasks. The second chip (offload processor) 106 is a smaller chip that is used to implement the offloaded networking tasks.

The host 108 adds offload tags to the ethernet frame header of ethernet frames for the offloaded networking tasks. A driver or a portion of the operating system stack at the host 108 can implement these and other functions related to the offloaded networking tasks.

The first chip 104 passes ethernet frames to the second chip 106. The second chip 106 receives the ethernet frames from the first chip and examines the ethernet frames for an offload tag in the ethernet frame header. When an ethernet frame with the offload tag is found, the second chip 106 processes the etherenet frame according to the offloaded networking task.

In addition to the ethernet frame header, the ethernet frames carry data. In the example of the TCP/IP offloaded networking tasks, the data payloads of the ethernet frames contain TCP/IP packets. The second chip 106 processes the TCP/IP packets in the payload of the ethernet frames that indicate that the offload task is to be done. The second chip repackages the processed TCP/IP packets as payload in outgoing ethernet frames and removes the offload tag from the ethernet frame header of the ethernet frames. The second chip 106 then sends the Ethernet frame out to the network 110.

The offload tasks can be a TCP/IP offload task such as an IPsec offload task, a check sum task, a TCP segmentation task or some other offloaded task. As new offloaded tasks are created, the architecture of FIG. 1 allows for these new tasks to be supported by a new chip 106 without requiring significant hardware changes to the ethernet controller chip 104.

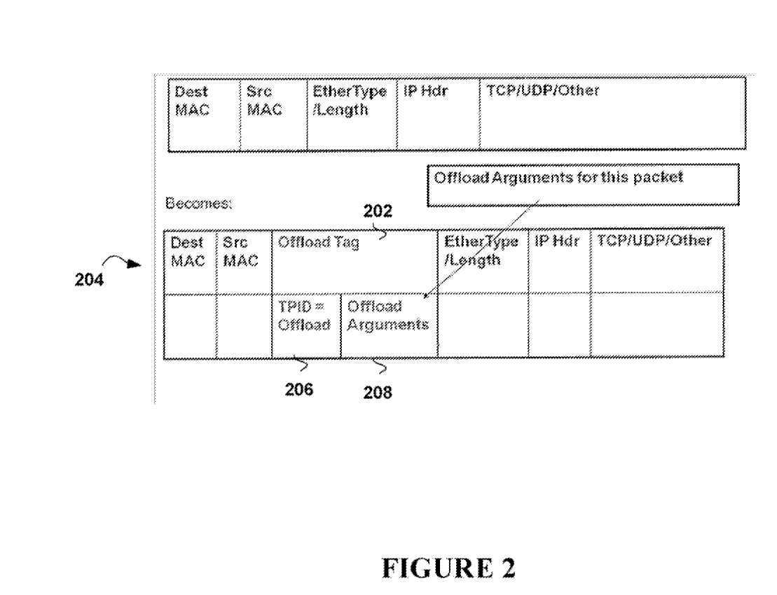

FIG. 2 shows the insertion of an offload tag 202 into an ethernet frame header 204. The offload tag 202 includes a tag protocol identifier (TPID) 206 that indicates an offload. Since the offload tag gets stripped away before the frame goes out to the network, the TPID 206 can be any otherwise unused value. The offload tag 202 also includes offload arguments 208. Offload arguments 208 are values that are provided to the second chip 106 to allow the second chip 106 do the offloaded networking task.

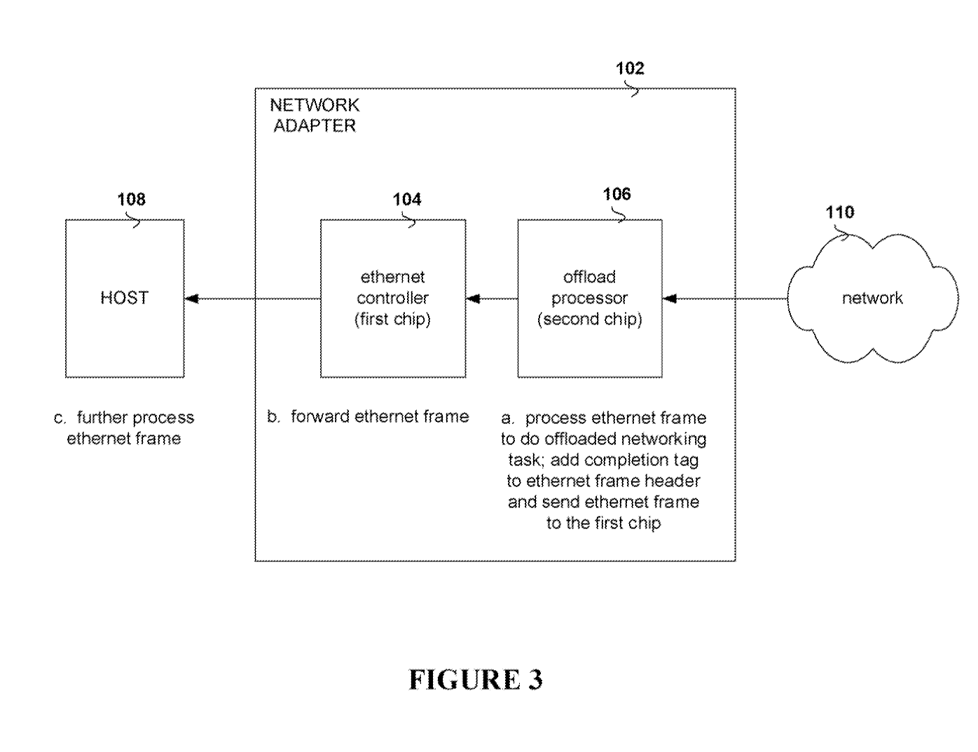

FIG. 3 shows the processing of an incoming frame from the network 110. The second chip 106 processes the ethernet frame according to the offloaded networking task. After processing, the second chip 106 adds a completion tag to an ethernet frame header of the ethernet frame. The completion tag indicates the completion of the processing of the ethernet frame.

The second chip 106 checks the TCP/IP payload of the incoming ethernet frames and processes the TCP/IP packet payload of relevant frames for an offloaded task. For example, the TCP/IP packets can be checked for IPsec protocol information, and then processed. The processed TCP/IP packet payload is repackaged into ethernet frames with the completion tag added to the ethernet frame header.

The second chip 106 forwards the ethernet frame to a first chip 104 that passes the ethernet frame to host 108. As a result of the completion tag, the host 108 will then know that the ethernet frame was processed for the offloaded task by second chip 106.

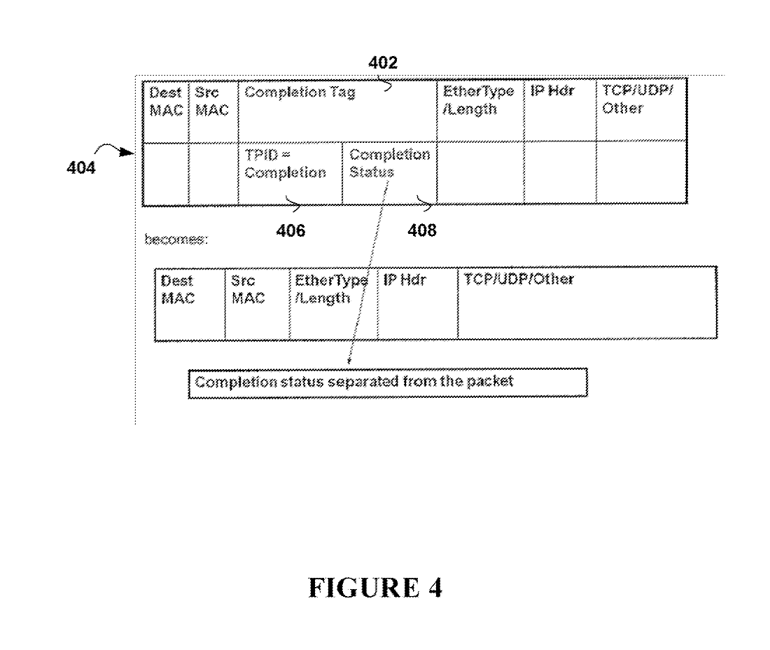

FIG. 4 shows a completion tag 402 which is part of the ethernet frame header 404. The completion tag includes a TPID 406 that indicates the completion and a completion status field 408. The completion tag TPID can be either the same as the offload tag TPID or a different value, depending on the implementation.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A network adapter comprising:
a first chip passing an ethernet frame to a second chip, the first chip implementing an ethernet controller; and
the second chip receiving the ethernet frame from the first chip and examining the ethernet frame for an offload tag in an ethernet frame header.

2. The network adapter of claim 1, wherein the second chip processes the ethernet frame to do an offloaded networking task.

3. The network adapter of claim 1, wherein the offload tag includes an offload ID and offload argument.

4. The network adapter of claim 1, wherein the offload task is an IPsec offload task.

5. The network adapter of claim 1, wherein a host adds the offload tag to the ethernet frame header.

6. The network adapter of claim 5, wherein the outgoing frames go from the host to the first chip to the second chip to a network.

7. The network adapter of claim 1, wherein the second chip adds a completion tag to the ethernet frame header of frames that come in from a network.

8. The network adapter of claim 7, wherein the second chip adds the completion tag to the ethernet frame header after processing the incoming frames.

9. A method comprising:
adding an offload tag to an ethernet frame header of a ethernet frame, the offload tag indicating that an offloaded networking task is to be done to the ethernet frame; and
processing the ethernet frame in accordance with the offload tag.

10. The method of claim 9, wherein the offload tag includes an offload ID and offload arguments.

11. The method of claim 9, wherein the offload task is an IPsec offload task.

12. The method of claim 9, wherein a host adds the offload tag to the ethernet frame header.

13. The method of claim 12, wherein the host sends the ethernet frame to a first chip that is an ethernet controller which forwards the frame to a second chip that processes the ethernet frame in accordance with the offload tag.

14. The method of claim 13, wherein the second chip sends the ethernet frame out to a network.

15. A method comprising:
processing an ethernet frame for an offloaded networking task; and
adding a completion tag to an ethernet frame header of the ethernet frame, the completion tag indicating the completion of the processing of the ethernet frame.

16. The method of claim 15, wherein a second chip processes the ethernet frame and adds the completion tag.

17. The method of claim 16, wherein the second chip forwards the ethernet frame to a first chip that passes the ethernet frame to a host.
